(19) United States
(12) Patent Application Publication
(10) Pub. No.: US 2003/0005657 A1
(43) Pub. Date: Jan. 9, 2003

(54) Sealing on settlement joints and process for preparing it

(75) Inventors: Cornelius Visser, Am Zwolle (NL); Hermann Kaschuba, Niedernwoehren (DE); Dieter Roeske, Tecklenburg (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Triflex Beschichtungssysteme GmbH & Co.KG, Minden (DE)

(21) Appl. No.: 10/178,741

(22) Filed: Jun. 25, 2002

(30) Foreign Application Priority Data
Jun. 25, 2001 (DE) 101 30 503.6

(51) Int. Cl. F27D 1/00; E04B 1/68; E04B 1/686

(52) U.S. Cl. 52/396.01; 52/396.03

(57) ABSTRACT

The invention relates to a sealing (1) on settlement joints, having a moveable loop-shaped ribbon (2) between the joint edges (3) and having an angle section (4), wherein the loop has a support ribbon (2) and on top thereof at least one sealing layer(s) (5, 5′) produced on the basis of a pourable plastic with a plastic-fleece protruding at the borders of said support ribbon, which extend(s) beyond the ends of the support ribbon (2).

The invention relates also to such an embodiment, that between the vertical arms of the angle section (4) in the joint there is present a precompressed foam sealing tape (9).

Furthermore, the invention relates to a process for the production of the above-mentioned sealing by applying the support ribbon (2) and the sealing layer(s) (5, 5′) onto the horizontal subsoil (6) and by securing them thereon as well as by fixing the angle section (4) to the horizontal subsoil (6) by heavy-duty dowels (11) and countersinks (12), which are screwed into these, wherein the fixation of the angle section (4) is carried out in such manner, that a slowly reacting resin (14), in particular epoxy resin, is injected into the borehole (13).

### DESCRIPTION

The invention relates to a sealing on settlement joints and a process for preparing the same.

For sealings on settlement (expansion) joints, loops between the joint edges, for example made of rubber or plastic webs, were already known. These known webs can assure the seal indeed, however not homogeneously enough, and they are not directly trafficable.

A cover-like fire protective sealing in expansions joints is known from U.S. Pat. No. 5,875,598. The cover or sealing, respectively, is inserted in the expansions joints according to the kind of a loop, and is affixed over two separate angle sections by nails or screws to a horizontal subsoil (ground). The cover or sealing, respectively, consists of three to four layers, of which a first lower layer is manufactured of a flame-retardant material such as Zetex. On top thereof, another layer is provided which is prepared of a heat resistant material such as Refrasil®. On top thereof in turn, a further layer is provided, which serves as an insulating layer, preferably made from Kaowool. An uppermost layer, again, consists of a flame-retardant material. The four layers are connected with each other in a cover-like way. All layers, except the insulation layer, have crinkles in a regular spacing. The crinkles permit a longitudinal offset of the two opposing edges of the settlement joint. A vertical offset as well as a transverse offset are compensated by the loop formation.

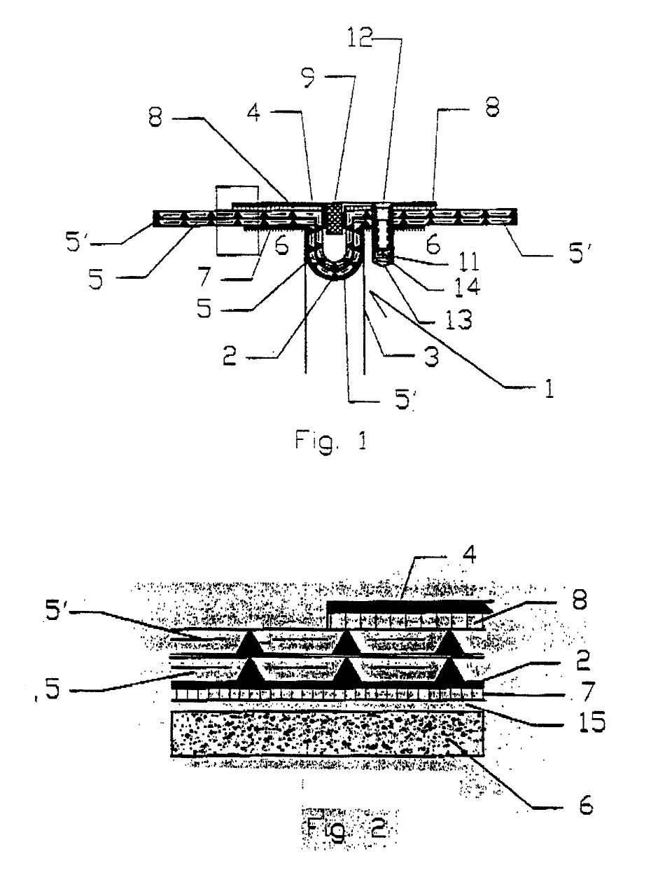

This document does not disclose to manufacture the ribbon from a support ribbon and a sealing layer on the basis of a pourable plastic having a plastic fleece protruding at the borders of said support ribbon. In the illustration of the FIG. 1 of U.S. Pat. No. 5,875,598, the four layers of the cover appear to have approximately equal length in the transverse direction.

In DE 71,08,905 U there is also described a joint covering. Therein, one anchoring knee each is provided at both side flanks of the joint. From this, arms are protruding, which are encompassed by U- bar-shaped intermediate section. The intermediate sections have protuberances matching with depressions of a resilient section, which bridges the settlement joint. The depressions at the bottom side of the section are arranged at distance from its outer edges. In this embodiment, the sealing itself consequently is an one-part section made of a resilient material. However the kind of the material is not specified.

Thus, this specification also does not disclose the idea to produce the movable ribbon of one support ribbon and at least one sealing layer on the basis of a pourable plastic with a plastic-fleece protruding at the borders of said support ribbon.

From DE 41 14 507 C2 a bridging construction for settlement joints in bridges, parking decks or similar building structures is known. Therein, an upward-opened joint channel is formed by two lateral metal sections. A lower settlement strip bridges the distance between the metal sections and is made of a pliable resilient material. Further, above the settlement strip, a structural foam section is inserted with biasing. The structural foam section is shaped such that the void of the joint channel above the structural foam section maintains essentially a constant volume, even with a broadening or narrowing of the settlement joint. Said void is filled with a permanent resilient filling mass (potting composition).

The settlement (expansion) strip is affixed to the two metal sections laterally, not from the upward direction. The settlement strip is forming a loop.

The permanent resilient filling mass may consist of softener-free, cold or hot curing 2-K-epoxide systems, 2-K-polymethane systems or 2-K-epoxide/polymethane systems on the basis of amino- and/or polyaminoamide functional hardeners. These polymer systems may contain accelerators according to the state of the art.

The void-forming structural foam section preferably consists of native rubber or similar materials.

In this document, too, there is not disclosed to produce the loop from a support ribbon and a sealing layer made on the basis of a pourable plastic having a plastic-fleece protruding at the borders of said support ribbon. Rather, the permanent resilient filling mass is not applied, before a shaped foam section is placed onto the support ribbon (the settlement strip), which essentially fills up the settlement joint.

The U.S. Pat. No. 3,849,958 also relates to a covering for an settlement joint. Herein, similar as in the document DE 41 14 507 C2, a flexible moisture-shielding loop is situated between two metal sections. The loop endings are situated at the lateral walls of the respective angle sections, not on the top surface of the angle sections.

Both angle sections each form a shoulder, over which a bridging member can be laid. Subsequently a filling mass is filled-in on top of the bridging member.

In GB 1,051,882 an settlement joint is bridged by a flexible insert, which is shaped semi-circular at its bottom side. Furthermore, at the bottom side there are incorporated two reinforcing layers in the insert, which each are provided around a rod. The rods are clamped between two metal plates.

The sealing is not formed by a ribbon but by an insert, whose bottom sides are reinforced by reinforcing layers, which are flexible but not expandable. Additionally, the insert is not extending beyond these reinforcing layers. Rather, the reinforcing layers embrace the flexible insert.

DE 196 49 476 C2 relates to a process for the subsequent sealing of building joints between component parts of concrete, and to the joint seals thus obtained.

Therein especially such building joints are contemplated, which are present at the bottom side of component parts. For providing a seal, at first a sealing strip of resilient plastic is laid smoothly, without loop formation, against the concrete component parts from the downside. A metal rail is laid on top of this, and is anchored by dowels and screws in the concrete component parts. Via injection pipes a pourable sealing compound is filled in, through the sealing strips and metal rails, into the joint interstice, such that a certain fluid level (filling depth t), starting from the inside of the sealing strip, is obtained.

This document does not even disclose the idea of a loop formation.

DE 87 15 428 U1 describes a sealing strip of two foam strips having the same cross section area, which are made of impregnated open-celled plastic foam. Such a plastic foam commonly is supplied in a compressed form in a composite coil. After unrolling, with a delay the same expands itself to a considerably larger volume. Thus, when such a strip is introduced into a gap or joint in compressed state, it will subsequently expand slowly and can match ideally the usually irregular shape of the gap or joint.

Between the sealing strips therein, a flexible strip of a heat-foaming material is located, which is connected with both foam strips. In case of fire, the foaming of the heat-foaming strip is initiated, and thereby the joint is filled up, even at high temperatures.

However, the joint filling is not water-proof.

For the sealing, there is not provided a ribbon. It is not envisaged either, to form a loop.

From DE 40 20 333 A1 a sealing tape for settlement joints of structures is known. Therein such a settlement joint between two damming boards is bridged as follows: in the joint between the damming boards a plastic film strip is deposited as a loop. The plastic film strip consists of nitrile rubber having a fabric inlay. The fabric inlay therein is wider, and extends also beyond the horizontal subsoil to the left and the right of the joint. The nitrile rubber at the other hand, is provided only until the edges or until a short distance behind them, as can be seen from FIG. 2 and column 4, lines 30 to 33. Onto the protruding fabric tape on each side of the settlement joint is laid a so-called armouring strip. The armouring strip consists of a netting of glass fiber strands. In the region of the longitudinal edges of the joint, this netting is weakened such that a default buckling section results. Consequently, the armouring strips are bended into the settlement joint, such that an accurate alignment and fitting in respect to its edge is permitted.

Neither the protruding fabric tape nor the armouring strip are sealing materials.

Further, at the bottom side, i.e. the side facing to the joint interior, an additional protection strip of plastic film (e.g. PVC) may be provided on the plastic film strip.

Into the settlement joint there can optionally be inserted a resilient settlement joint tape. Thereafter, a fixation of the plastic film tape and of both armouring strips to the outward side of the damming is performed by applying an armouring plaster, optionally with interposing of a further glas fiber fabric. At last, coating with weather-proof outside plaster is conducted.

Quite evidently, this document is concerned with a facade joint in a thermal protection combinatory system (including thermal insulation and outside plaster). Besides, in a thermal-combinatory system, innately, no plane sealing is provided (it also would be completely spurious). Thus, the system components of this document are suitable only for a sealing of the joint itself without area-junction.

Also in this document it is not disclosed, to provide still one further sealing layer or several such sealing layers of pourable plastic, which even would protrude beyond the end of the support ribbon, on said tape. The support tape may, at best, be provided with an additional reinforcing PVC layer at the inner side.

DE 295 11 398 U1 discloses only a fabric tape of plastic fibers for bridging cracks in wall surfaces before being painted. The wall-faced surface of the plastic fabric is presenting a permanent adhesive coating of an adhesive glue, which is covered by a protective film.

In DE 88 04 605 U1, there is described a coating web for producing seals of structure and facility parts having a cover layer and an adhesion layer, which is tightly attached to the same. Therein, the cover layer at one side is fully plane-covered by the single- or multilayer design adhesion layer, and the entire adhesion layer is soaked with an activatable adhesive or with one of the components of a two-membered adhesive.

Therein too, it is essentially envisaged to bridge cracks and the like. The adhesion tape is not inserted in the joint in loop form, but is applied smooth-faced over a joint.

From DE 44 18 311 A1 there is only known a process for producing chemical resistant and liquid impermeable settlement joints. This is accomplished by pasting a section of a foamed polyolefine into the joint, wherein a chemically durable resin is used as an adhesive. Optionally, the horizontal surface adjacent to the joint can be pre-treated by a pre-coating which is identical with the adhesive.

DE 195 02 381 A1 only discloses heat-curing, one-membered structure adhesives based on liquid rubbers, wherein the composition contains a finely divided powder of thermoplastic polymers and has an elongation at break of more than 15% in the cured state.

DE 44 27 085 A1 only knows the production of floor and wall coverage's of textured plastic foam having a cover- or machine layer made of an ionomer.

The invention therefore is based on the object, to provide an homogenous, also horizontally existing seal for settlement joints, which permits an optimum absorption of movements from different directions, and the applicability for repeatedly occurring movements, and the direct trafficability, and which is combinable with an area sealing/coating, as well as to provide a process for producing the same.

The above was surprisingly accomplished by the invention.

The subject-matter of the invention is a sealing on settlement joints, having a moveable loop-shaped ribbon between the joint flanks and having an angle section, which is characterized in that the loop has a support ribbon and on top thereof at least one sealing layer(s) produced on the basis of a pourable plastic with a plastic-fleece protruding at the borders of said support ribbon, which extend(s) beyond the ends of the support ribbon, and the angle section is made of metal.

Thereby, the horizontal portions of the support ribbon are lying on top of portions of the horizontal subsoil in the vicinity of the joint, and the sealing layer(s) having the plastic-fleece is/are lying on top of an area of the horizontal subsoil, which is more distant from the joint.

The support ribbon used in the seal according to the invention, thus serves as an underlay for the joint sealing layer(s) produced on the basis of a pourable plastic having a plastic-fleece protruding at the borders of said support ribbon. This support ribbon having said sealing layer(s) assures a defined non-glued zone, which is freely movable within the joint. Due to the greater movability of the sealing layer(s) produced on the basis of a pourable plastic, the sealing of the invention, in comparison to the known joint seals, provides the advantage of greater movability. The examination of the joint sealing according to the invention in the dynamic oscillation test at −20° C. and 50° C. with 1,036,800 cycles having an amplitude of ±1 mm demonstrated full functionality.

There exists the fundamental difference between the invention and all said documents, that according to the invention there is present the loop of the combination of a support ribbon and on top thereof at least one sealing layer(s) produced on the basis of a pourable plastic with a plastic-fleece protruding at the borders of said support ribbon, which extend(s) beyond the ends of the support ribbon.

Thus, a greater movability (flexibility) is assured. The support ribbon prevents an undesired flank adhesion on both sides of the joint construction, which would critically limit the flexibility. Trials using the pourable plastic alone showed, that it had formed an undesirable linkage with the joint flanks, which resulted in a limitation of the expansion path length, and thus in tearings in the loop. This was overcome by the non-obvious combination according to the invention.

The combination according to the invention with the support has the further advantage of faciliating the installation and preventing the dripping of the pourable plastic during the installation, and thus is excluding reaction perturbations, which is critical for the functionality of the sealing loop.

The plastic-fleece incorporated in the pourable plastic, has the function to increase the mechanical strength. Thus, the joint sealing according to the invention is characterized in that it is trafficable by at least one passenger car.

A further advantage of the joint sealing according to the invention over those of all documents mentioned, and therefore also of DE 41 14 507 C2, having a resilient material as settlement strip between two metal sections (laterally anchored), a structural foam section and a permanent resilient filling mass, resides therein, that the joint sealing of the invention, i.e. the combination of a support ribbon and at least one layer of pourable plastic having a plastic-fleece incorporated inside, protrudes over the ends of the horizontal portion of the angle section, and thus may be connected with an area sealing/coating homogenously in respect to material.

Especially as against DE 40 20 333 A1 there exists the additional substantial difference, that the angle section is made of metal, what is not comparable with the deposited armouring strip consisting of a netting of glass fiber strands according to said document. In the result, this leads to the substantial difference that the joint sealing according to the invention, in contrast to the construction of said document, can be trafficated by at least one passenger car.

In contrast to the construction of said document, wherein only the joint is sealed (by nitrile rubber), and a further sealing junction therefore is not provided, because neither the protruding fabric tape nor the armouring strip are sealing materials, the combination of the invention permits a material-homogenous junction, made of pourable plastic, and thus the connectivity with an area sealing/coating

Preferably the support ribbon has a spackle at its horizontal bottom side for assembly-fixation to the horizontal subsoil.

This also entails the advantages of a better fixation and the compensation of subsoil unevenness.

It is also preferred, that the pourable plastic is a poly(methyl methacrylate) resin. This material has the advantage of a more rapid reactivity, compared to other resins. Hence, it also can be processed at low temperatures such as 0° C. and has a higher Shore-hardness. This material allows for a more rapid fixation and a better securing to the subsoil.

Advantageously, the poly(methyl methacrylate) resin contains a flame-retardant agent, especially aluminium hydroxide. The flame-retardant property often is beneficial to prevent the propagation of fires, which may be of importance for parking decks in respect to the flammable fuel materials. Joint sealings according to the invention of this embodiment passed the fire inspection according to pertinent standards.

Preferably, the support ribbon consists of a rubber, compatible with the pourable plastic, having a plastic-fleece protruding at the borders. The special movability of such a material, which can be held very thin, is of considerable advantage in respect to the movability of the joint sealing.

Conveniently, the plastic-fleece is incorporated internally inside the support ribbon.

Preferably the rubber, which is compatible with said pourable plastic, is NBR rubber acrylonitrile/butadiene rubber.

It is also preferred, that the plastic-fleece is made of polyester and/or polyamide. Conveniently, the plastic-fleece of the support ribbon is made of polyester/polyamide, and the plastic-fleece of the sealing layer(s) is made of polyester.

Conveniently, there are two sealing layers present on the support ribbon.

Advantageously, the angle section having a spackle is applied on the top sealing layer, produced on the basis of a pourable plastic, and is secured thereover at the horizontal subsoil. The fact of the angle section being provided with a spackle, entails the advantages of a better fixation and the compensation of unevenness.

It is preferred, that the angle section is made of high-grade steel or aluminium, or an aluminium alloy, respectively.

Preferably, the spackle on the top sealing layer is based on a poly(methyl methacrylate) resin.

Conveniently, the space between the vertical arms of the angle section is filled up to avoid dirt pick-up in the loop.

According to a particular advantageous embodiment of the invention, between the vertical arms of the angle section in the joint there is present a precompressed foam sealing tape. This foam sealing tape can also advantageously be present in joint sealings of a different type.

This foam sealing tape effects an especially good protection against soiling for the loop. It also has the advantage, that it may be removed due to inspection according to established maintenance intervals, and after completed inspection, optionally also repair of the sealing, may be renewed again.

Preferably, the foam sealing tape is based on a polyurethane soft-foam. In particular, the same is open-celled. Such a material presents the advantages, that it is well sealing and can easily be renewed in course of maintenance operations, if required.

Advantageously, the polyurethane soft foam of the foam sealing tape is impregnated with a synthetic resin.

The synthetic resin-impregnation of the precompressed foam sealing tape is preferably an acrylate-dispersion impregnation.

Advantageously, the synthetic resin, with which the polyurethane soft foam of the foam sealing tape is impregnated, is set to be flame-retardant. This brings about the same advantages as the flame-retardant agent, described in relation with the sealing layers.

Conveniently, the polyurethane soft foam of the foam sealing tape is provided with a self-adhesive layer on one side. This provides a simplification in respect to the fixation to the vertical arms of the angle section.

However, in place of the foam sealing tape, another type of soil protection is also possible, for example a flexible plastic section.

The sealing according to the invention can be present as a self-contained system, in particular for parking decks and backyard cellar ceilings.

Yet, it also can be used in combination with area sealings/coatings, for example of parking decks.

According to a special embodiment of the sealing of the invention, therefore, on at least one horizontal border area of the top-most sealing layer, a sealing, produced on the basis of a pourable plastic having a protruding plastic-fleece incorporated with said pourable plastic, represents a junction area towards an area sealing/coating, in particular of a parking deck.

The subject-matter of the invention is also a special process for producing the joint sealing according to the invention by applying the support ribbon and the sealing layer(s) onto the horizontal subsoil and by securing them thereon as well as by fixing the angle section to the horizontal subsoil by heavy-duty dowels and countersinks screwed therein, characterized in that the fixation of the angle section is carried out in such manner, that a slowly reacting resin, in particular epoxy resin, is injected into the borehole. Hence, a sealing closure of the borehole is accomplished, whereby the use of a slowly reacting resin faciliates the assembly.

The production of the joint sealing according to the invention is further illustrated by the following exemplary statements in connection with the appending drawings.

FIG. 1 shows an embodiment of the joint sealing according to the invention as self-contained system, in longitudinal section through the joint,

FIG. 2 shows a section in magnification from FIG. 1's left side,

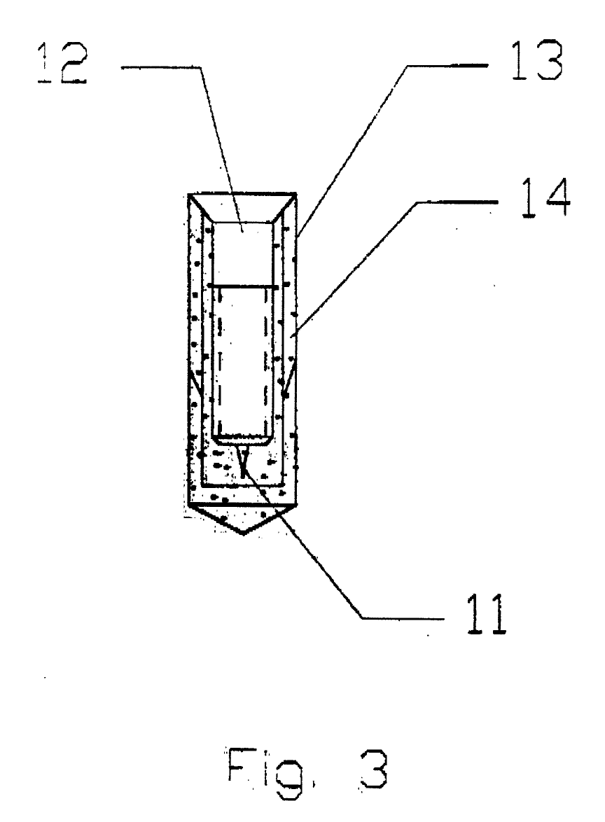

FIG. 3 shows a section in magnification from FIG. 1 from its right side, relating to the fixation of the angle section to the subsoil, and

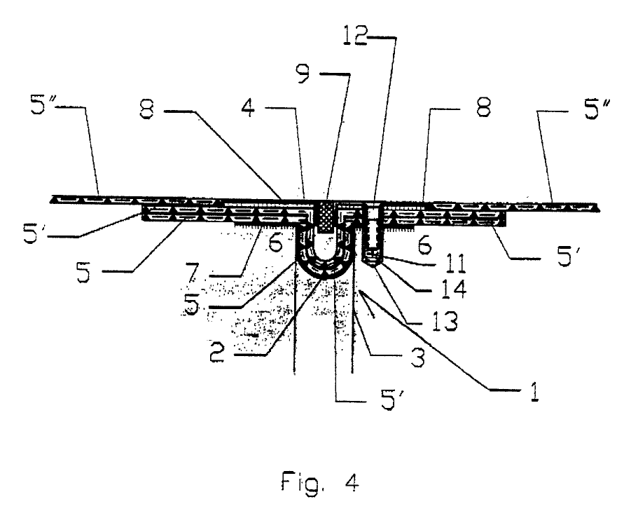

FIG. 4 shows a modification of the embodiment according to FIG. 1 for combination with a delimiting area sealing/coating.

The joint sealing as a whole is indicated with 1.

The joint sealing according to the invention conveniently can be produced as follows:

Conveniently, after preparing and priming the surface of the subsoil, the spackle (embedding material) 7 is applied on the horizontal subsoil 6 on both sides of the joint. Conveniently, the spackle 7 contains as base resin a poly(methyl methacrylate) resin and further an inhibitor solution for delaying the reaction, a wetting agent, a defoaming agent, a pigment, such as titanium dioxide and/or iron oxides, a thickening agent, and the filler aluminium hydroxide having flame-retardant properties. Preferably, the poly(methyl methacrylate) resin is present in quantitative proportions of 50 to 55% by weight, and the filler is present in quantitative proportions in part of 40 to 45% by weight, while the pigment and the thickening agent are present in quantitative proportions of 1 to 4% by weight, each, and the inhibitor solution, the wetting agent and the defoaming agent can be present in quantitative proportions of 0,1 to 1% by weight each; the concentration of the inhibitor solution may conveniently vary from 8 to 12% by weight. Then the support ribbon 2, conveniently a polyester/polyamide fleece with a center portion of NBR rubber having the protruding fleece termini, is inserted in the spackle.

Alternatively, at first the support ribbon 2 can be inserted in the spackle 7, and may be applied to the subsoil 6 with its spackle-face.

Subsequently, the thus-prepared support ribbon 2 is laid into the joint, under formation of a loop, between the joint edges 3, and is affixed to the horizontal surfaces of the subsoil 6, which are adjacent to them.

Then, onto this support ribbon 2 is laid a layer of pourable plastic and is applied extending to the right and left side of the support ribbon 2 onto an adjacent portion of the horizontal surface of the subsoil 6. Into this first layer of pourable plastic, a plastic-fleece is inserted and is soaked until total saturation with a second layer of pourable plastic and covered. Favorably, the sealing layer 5, prepared on the basis of a pourable plastic, contains a preferably pre-accelerated, internally flexibilized poly(methyl methacrylate) resin in quantitative proportions from 50 to 55% by weight and aluminium hydroxide in quantitative proportions from 40 to 45% by weight, as well as pigment of titanium dioxide and/or iron oxides in quantitative proportions from 1 to 8% by weight, amorphous silicon dioxide in quantitative proportions from 1 to 2% by weight as well as a 10% by weight inhibitor solution for reaction retardation, an alkyd resin modified with fatty acid, a 75% by weight solution of polyvinyl derivative, and a 52% by weight solution of polycarboxylic acid salt in quantitative proportions of 0,1 to 0,5% by weight, each; advantageously the concentration of the inhibitor solution can vary from 8 to 12% by weight, that of the polyvinyl derivative solution from 65 to 85% by weight, and that of the polycarboxylic acid salt solution from 45 to 60% by weight.

Subsequently, the latter process can be repeated one or several time(s) under formation of one or more further sealing layer(s) 5′, produced on the basis of a pourable plastic.

After curing of the joint sealing(s) 5, 5′ the angle section, favourably made of high-grade steel or aluminium, or an aluminium alloy, respectively, is covered with a spackle 8 at its bottom side, which conveniently may have the same composition as that one 7, which is present on the horizontal bottom side of the support ribbon 2, and is affixed to the top sealing layer 5′ by pasting.

For hardening this resin and other used resins, one can conveniently use a curing component, preferably a modified cycloaliphatic amine, and a catalyst, preferably dibenzoyl peroxide advantageously together with a softener, at a preferred quantitative proportion ratio of dibenzoyl peroxide to softener from 40:60 to 60:40, particularly 50:50, expressed on basis of the weight.

After curing of the spackle, dowel holes 13 are drilled at both sides of the joint. These boreholes 13 are filled up over the most part of their height with a slowly reacting resin 14, in particular epoxy resin (especially see FIG. 3).

Into them, on both sides of the joint, heavy-duty dowels (11), conveniently of high-grade steel, with countersink (12) are inserted and screwed-in (especially see FIG. 3).

Finally the foam sealing tape (9), advantageously made of precompressed polyurethane soft foam, which conveniently is provided with a synthetic resin-impregnation, preferably a precompressed acrylate dispersion-impregnation, and having a one-sided self-adhesive layer, is pasted between the vertical arms of the angle section 4.

The invention will be further illustrated by the following practical example.

### EXAMPLE

At first, the surfaces on both sides of the joint having a width of at least 3 cm, are pretreated (on both sides for about 20 cm, by grinding, grit-blasting or milling).

Then, the surface of the subsoil 6, if composed from concrete or concrete substitute products, was primed with a pre-accelerated poly(methyl methacrylate) resin [trade name: Triflex-Cryl Primer 276] (consumption: at least 400 g/cm²) or, respectively, two times with a modified epoxide resin [trade name: Triflex Pox R 100] (consumption: at least 2×300 g/cm²), including sanding after the last primer layer using quartz sand of grain size 0,2 to 0,6 mm (2 kg/m²), 15.

In ease of an asphalt surface, the priming 15 was performed with a flexibilized pre-accelerated poly(methyl methacrylate) resin (trade name: Triflex-Cryl Primer 222) (consumption: at least 400 g/m²).

Thereafter, a spackle as embedding material (assembly-fixation) was applied on both sides of the joint onto a section of the horizontal surface of the subsoil 6, adjacent to the joint. This spackle 7 had the following composition:

| Ingredients | Parts by weight |
|---|---|
| base resin | 53.000 |
| poly(methyl methacrylate) resin | |
| inhibitor solution for reaction retardation | 0.500 |
| 10% by weight | |
| wetting agent | 0.200 |
| defoaming agent | 0.300 |
| pigment | |
| titanium dioxide, iron oxides | 2.000 |
| thickening agent | 2.000 |
| aluminium hydroxide | 42.000 |
| | 100.000 |

A support ribbon 2 of polyester/polyamide fleece having a center portion of NBR rubber was pressed in the fresh spackle with the protruding fleece endings without crinkles.

Then a compound of pourable plastic for formation a sealing layer 5 was pre-laid with a fur roller, about 20 cm each on both sides of the joint as well as on the support ribbon 2 of each joint (consumption: about 2.0 kg/M²).

Thereafter, a polyester fleece was inserted by way of loop formation. An optionally required overlapping of the fleece endings in longitudinal direction (butts) b conveniently was 5 cm. The fleece layout (b) is dependent from the joint width, however at least 50 cm.

Subsequently, the pourable plastic of the above-mentioned composition, was applied immediately after the preparation until the total saturation of the fleece (consumption: about 2.0 kg/M²). Thus the first sealing layer 5 was produced.

Both latter operation steps were repeated, whereby the second sealing layer 5′ was produced.

After curing (reaction), the joint sealing 1 was solubilized in the horizontal portion with ethyl acetate (venting time: about 20 minutes).

Then, an angle section 4 of high-grade steel (Material No. 1.4301) 100×20×3 mm, or of AlMgl 100×20×3 mm (L=2.00 to 2.50 m, distance of the boreholes 15/20 cm, distance from the rear edge of the horizontal 100 mm width arm was approximately 40 mm) was degreased with ethyl acetate and roughened at its bottom side. This angle section was covered with the spackle 8 of the further above indicated composition on its bottom side (d=about 2 mm) and pasted, such that between the section butts there was a distance of at least 2 mm. Excess spackle 8 was removed.

After the hardening of the spackle 8 (about 1 hour) dowel holes 13 (diameter: about 12 mm) were drilled. The boreholes 13 were aspirated by a vacuum cleaner, and filled up with a modified epoxy resin until approximately 1 cm underneath the top edge of the angle section surface 4 by injection via a disposable syringe.

Then, heavy-duty dowels 11 having a thread M 8, made of zinc-plated steel, with countersink 12, were inserted and screwed up. The excess epoxy resin 14 was removed.

Finally, a foam sealing tape 9 of polyurethane soft foam having a pre-impregnation of acrylate dispersion (precompressed) was pasted between the vertical arms of the angle section 14.

1. A sealing on settlement joints, having a moveable loop-shaped ribbon between the joint edges and having an angle section, characterized in that the loop has a support ribbon and on top thereof at least one sealing layer(s) produced on the basis of a pourable plastic with a plastic-fleece protruding at the borders of said support ribbon, which extend(s) beyond the ends of the support ribbon, and the angle section is made of metal.

2. A sealing according to claim 1, characterized in that the support ribbon has a spackle at its horizontal bottom side for assembly-fixation to the horizontal subsoil.

3. A sealing according to claim 1, characterized in that the pourable plastic is a poly(methyl methacrylate) resin.

4. A sealing according to claim 3, characterized in that the poly(methyl methacrylate) resin contains a flame-retardant agent, especially aluminium hydroxide.

5. A sealing according to claim 1, characterized in that the support ribbon consists of a rubber, compatible with the pourable plastic, having a plastic-fleece protruding at the borders.

6. A sealing according to claim 5, characterized in that the rubber, which is compatible with said pourable plastic, is NBR rubber (acrylonitrile/butadiene rubber).

7. A sealing according to claim 5, characterized in that the plastic-fleece is made of poly-ester and/or polyamide.

8. A sealing according to claim 1, characterized in that two sealing layers are present on the support ribbon (2).

9. A sealing according to claim 1, characterized in that the angle section with a spackle is applied on the top-most sealing layer, produced on the basis of a pourable plastic, and is secured there-over at the horizontal subsoil.

10. A sealing according to claim 1, characterized in that the angle section is made of high-grade steel or aluminium, or an aluminium alloy, respectively.

11. A sealing according to claim 9, characterized in that the spackle on the top-most sealing layer is based on a poly(methyl methacrylate) resin.

12. A sealing, especially according to claim 1, characterized in that between the vertical arms of the angle section in the joint there is present a precompressed foam sealing tape.

13. A sealing according to claim 12, characterized in that the foam sealing tape is based on a polyurethane soft-foam.

14. A sealing according to claim 13, characterized in that the polyurethane soft foam of the foam sealing tape is open-celled.

15. A sealing according to claim 13, characterized in that the polyurethane soft foam of the foam sealing tape is impregnated with a synthethic resin.

16. A sealing according to claim 12, characterized in that the precompressed foam sealing tape has a acrylate-dispersion impregnation for the synthethic resin-impregnation .

17. A sealing according to claim 13, characterized in that the synthethic resin, with which the polyurethane soft foam of the foam sealing tape is impregnated, is set to be flame-retardant.

18. A sealing according to claim 13, characterized in that the polyurethane soft foam of the foam sealing tape is provided with a self-adhesive film on one side.

19. A sealing according to claim 1, characterized in that, on at least one horizontal border area of the top sealing layer, a sealing produced on the basis of a pourable plastic having a protruding plastic-fleece incorporated with said pourable plastic, represents a junction area towards a plain sealing/coating, in particular of a parking deck.

20. A process for the production of the sealing according to claim 1 by applying the support ribbon and the sealing layer(s) onto the horizontal subsoil and by securing them thereon as well as by fixing the angle section to the horizontal subsoil by heavy-duty dowels and countersinks screwed therein, characterized in that the fixation of the angle section is carried out in such manner, that a slowly reacting resin, in particular epoxy resin, is injected into the borehole.
